(19) United States
(12) Patent Application Publication
(10) Pub. No.: US 2004/0003544 A1
(43) Pub. Date: Jan. 8, 2004

(54) Integral glassrun, glass tracking, and regulator system with optional integral applique

(75) Inventors: David Harold Berry, Northville, MI (US); Jonathan W. Fisk, Canton, MI (US); John David Mullett, Westland, MI (US)

Correspondence Address: Timothy E. Nauman, Fay, Sharpe, Fagan, Minnich & McKee, LLP, 7th Floor, 1100 Superior Avenue, Cleveland, OH, 44114-2518, US

(73) Assignee: COOPER TECHNOLOGY SERVICES, LLC.

(21) Appl. No.: 10/189,126

(22) Filed: Jul. 2, 2002

(51) Int. Cl. B60J 1/16; E05F 11/48

(52) U.S. Cl. 49/374; 49/372; 49/349; 49/352

(57) ABSTRACT

An integrated glassrun and window regulator assembly is provided. Various lift assembly portions (screw drive, drive belt, flexible cable) can be used to selectively raise and lower a window glass. An integral glassrun extrusion provides a guiding function of the window glass as it proceeds between the raised and lowered positions, and also functions to seal against the external elements along the front, upper, and rear edges of the glass when in the window is in a closed or raised position. A substantial reduction in weight results from the integrated assembly, in addition to eliminating relays, electric switches, reducing electrical wire size, and reducing the cost of manufacture and assembly.

### BACKGROUND OF THE INVENTION

The present invention relates generally to glassrun, glass tracking, and regulator systems associated with automotive windows and, more particularly, to a modular assembly.

Weatherseal systems for drop window applications are well known in the art. For example, the assignee of the present application commonly owns U.S. Pat. No. 4,932,161; 5,054,242; 5,702,148; and 5,092,078. U.S. Pat. No. 5,092,078 is incorporated herein by reference. As noted in the '148 patent, it is common for an automotive window surround molding to be formed from multiple components or pieces. Glassrun channels are used to support windowpanes that translate between open and closed positions, i.e. drop windows, guiding the window glass along front and rear vertical edges during such a movement between open and closed positions. The glassrun channel forms a seal between the window and the vehicle door or body structure. As disclosed in the '078 patent, a glassrun channel assembly is integrated with a decorative applique. Appliques are commonly used to provide an aesthetically pleasing surface that covers manufacturing imperfections and the like on a structural portion of the automotive vehicle. For example, the “B” pillar separates the front window from the rear window or doors of a vehicle and, prior to the '078 patent, it was common to provide a separately mounted applique to cover the external surfaces of the “B” pillar. This type of structure satisfied the increasing demand for limiting multiple installation steps on a vehicle assembly line and reducing wind resistance, as well as providing a smoother transition surface.

The regulator or lift assembly for a window can adopt a wide variety of structures, for example, as seen in U.S. Pat. Nos. 5,927,020; 6,134,840; 6,305,129; and 6,354,652. In addition to concerns relative to the cost of assembly and integrating the functional operation of separate components, weight is a primary concern. Typically, the glassrun assembly is manufactured and supplied to the automotive companies by a first manufacturer and the window regulator/lift assembly is supplied by a separate manufacturer. Thus, integration of these individual systems does not occur until assembled to the vehicle door.

A need exists to reduce the weight of these components, decrease final assembly cost, and coordinate the function and operation of the individual systems.

### SUMMARY OF THE INVENTION

The present invention provides an integrated glassrun and window regulator assembly that overcomes the above-noted problems and others.

An exemplary embodiment of the integrated glassrun and window regulator assembly includes a glassrun assembly dimensioned for receipt within an associated door window opening and having a channel with inner and outer surfaces dimensioned to receive an associated window edge therein. A lift assembly is unitarily joined for mounting as a single module and an associated vehicle door.

At least a portion of the lift assembly extends into the channel of the glassrun.

In one exemplary embodiment, the lift assembly includes a screw drive member and a follower adapted to be secured to an associated window.

According to another exemplary embodiment, the lift assembly includes a flexible cable driven by a motor and the cable extends along at least one side of the integrated assembly.

In another exemplary embodiment, the lift assembly includes drive and idler sprockets in spaced relation and a flexible band in closed loop relation therewith. A reinforcing member may be incorporated into the integrated assembly. The reinforcing member may be either a metal or non-metal component. The reinforcing member may be imbedded within an extruded profile or the extruded profile can be non-reinforced and the structural reinforcement can be derived from an external rigid bracket in which the non-reinforced extrusion is placed.

A primary advantage of the invention is the ability to use a low current lift system that reduces electrical wire size, and eliminates the need for relays and reduces the electrical current rating of the electric switches. These reductions lower the cost of the electrical system of the automotive vehicle.

Another advantage of the invention relates to the reduced cost of the integrated system relative to manufacture and assembly of the individual components or subsystems.

Still another advantage of the invention relates to the substantial weight reduction per door.

Yet another advantage relates to the simplified assembly process.

Still other advantages and benefits of the invention will become apparent to those skilled in the art upon reading and understanding the following detailed description.

### BRIEF DESCRIPTION OF THE DRAWINGS

FIG. 1 is a perspective view of the integrated glassrun and window regulator assembly.

FIG. 2 is an elevational view of the integrated assembly with the window removed for ease of illustration.

FIG. 3 is a side view taken generally from the right hand side of FIG. 2.

FIG. 4 is an enlarged cross-sectional view taken generally along the lines A-A of FIG. 3.

FIG. 5 is a partially exploded perspective view of a coupling assembly used in the integrated assembly.

FIG. 6 is a view similar to FIG. 5 further illustrating selected components in assembled relation.

FIG. 7 is a view similar FIGS. 5 and 6 after further assembly.

FIG. 8 is an elevational view of another embodiment of the integrated assembly.

FIG. 9 is a side view taken generally from the right hand side of FIG. 8.

FIG. 10 is an elevational view of another embodiment of the integrated assembly.

FIG. 11 is a cross-sectional taken generally along the lines 11-11 of FIG. 10.

FIG. 12 is an elevational view of yet another embodiment of the integrated assembly.

### DETAILED DESCRIPTION OF THE INVENTION

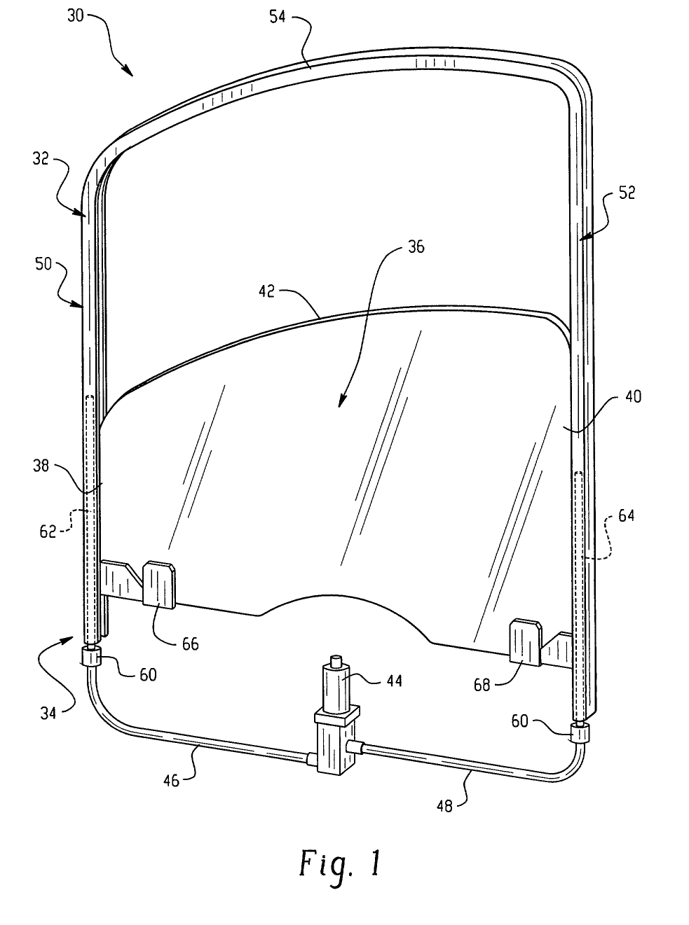

FIG. 1 illustrates an integrated glassrun and window regulator assembly 30. More particularly, the integrated assembly includes a first or upper portion 32, also referred to herein as the glassrun assembly portion, and a second or lower portion 34, also referred to as the regulator or window lift assembly portion. A window 36 includes first and second edges, or front and rear sides, 38,40 that are captured in the integrated assembly and adapted for sliding, translational movement as the lift assembly selectively raises and lowers the window. When positioned in a fully closed, or up position, a third or upper edge 42 is sealingly captured in the glassrun in a manner generally known in the art.

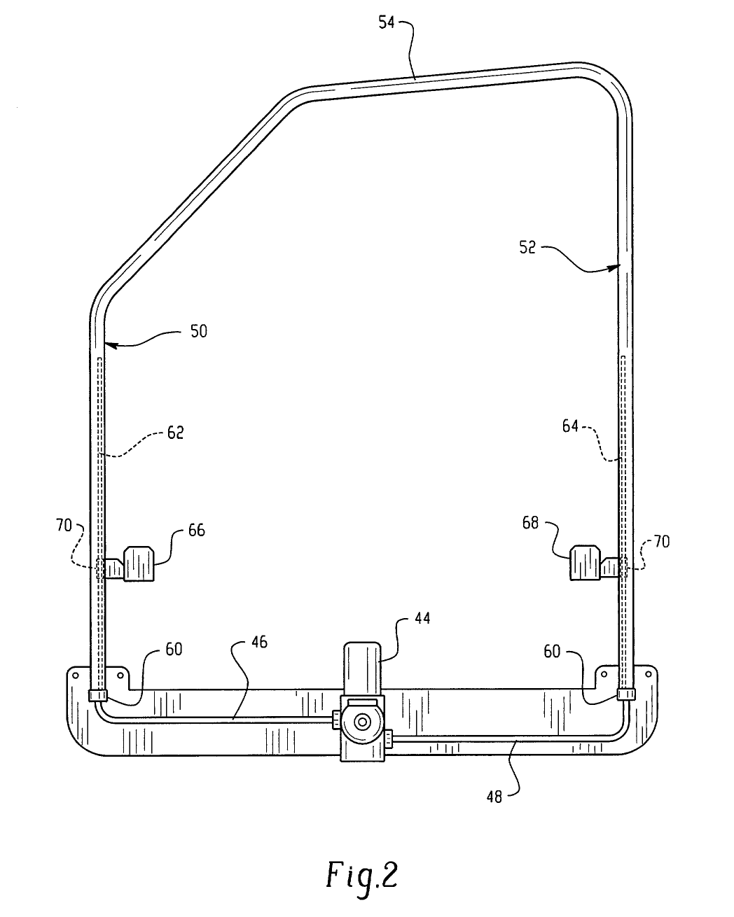

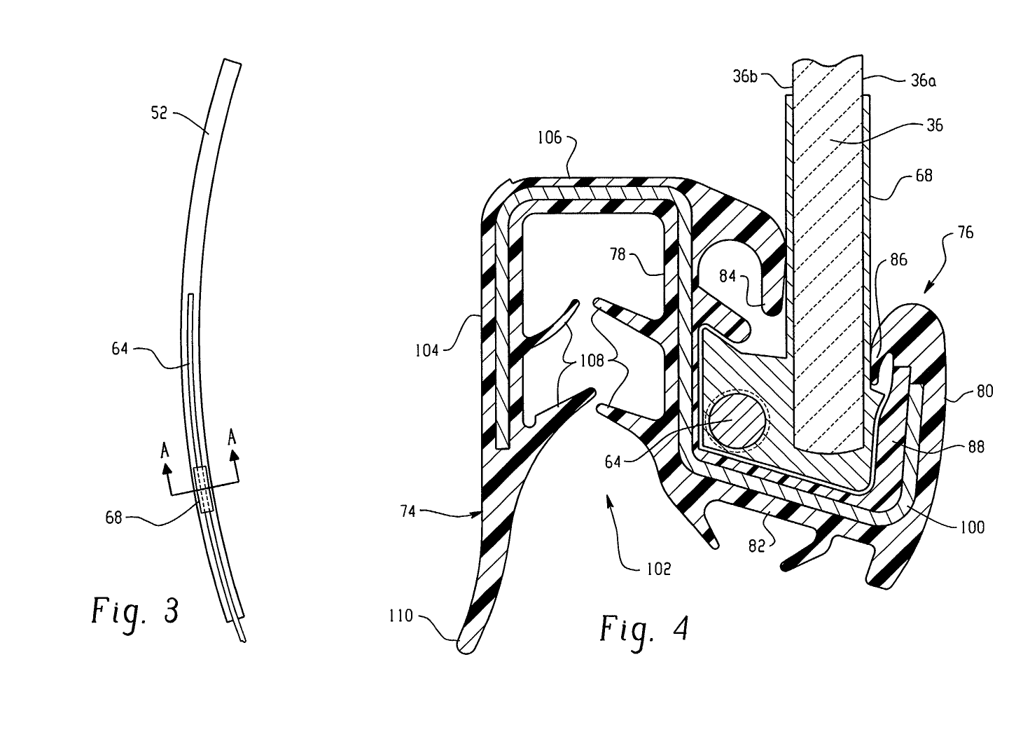

With continued reference to FIG. 1, and additional reference to FIGS. 2-4, the integrated glassrun/lift assembly 30 will be described in greater detail. It includes a reversible motor 44 that is typically a small electric motor on the order of 5-10 amps & 12 volt dc. First and second drive shafts are driven by the motor. The drive shafts extend toward front and rear pillars 50, 52, of a composite weatherstrip or weatherseal extrusion, the details of which will be described further below. An upper or interconnecting portion 54 of the extruded weatherstrip is integrally formed with or connected to the front and rear pillars. As will be appreciated, each of these portions 50, 52, 54 have a channel or generally U-shaped configuration dimensioned to sealingly capture the edges 38, 40, 42, respectively of the window and as will be described in greater detail below.

In the embodiment of FIGS. 1-4, the first and second drive shafts 46,48 are flexible structures that bend through an angle of approximately ninety degrees as they extend from the motor and terminate in connector assemblies 60, although it will be appreciated that other means for driving the drive shafts can be used. The structural details of the connector assemblies are further described below. As will be appreciated, the connector assemblies allow an easy snap-fit connection between the drive shafts and associated rotatable threaded shafts or screws 62, 64 provided in the front and rear pillars 50, 52, respectively. The screws are rotatably received within the front and rear pillars so that upon selective rotation, glass attachment members 66, 68 secured to the window selectively raise and lower the window between open and closed positions. Each glass attachment member includes a threaded opening 70 matingly received over one of the first and second screws 62, 64. Thus, as the screws are rotated, the glass attachment members are raised or lowered and move as linear followers on the screws to raise and lower the window. The glass attachment members 66, 68 are secured to the window glass 60 in a conventional manner, e.g., U-shaped bracket, adhesive, etc. Since the screws are driven from a common motor, the attachment members lift the front and rear edges of the window in unison.

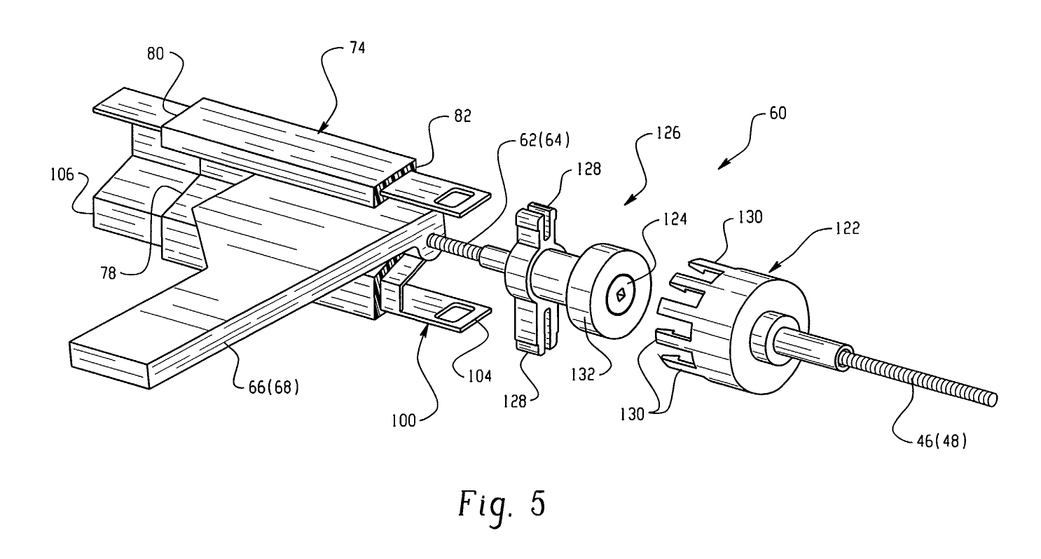

As more particularly illustrated in FIG. 4, a preferred arrangement of the front and rear pillars is illustrated in cross-section., A rubber, plastic, or combination rubber/plastic extrusion 74 has a first U-shaped portion or channel 76 defined by spaced first and second legs 78, 80 interconnected along a base region by a third or interconnecting leg 82. Seal lips 84, 86 extend inwardly from edges of the first and second legs 78, 80, respectively, for sliding, sealing engagement with the inner and outer surfaces 36a, 36b of the window. In addition, a low friction material 88 (shown here as an integrally extruded, generally U-shaped material) is dimensioned to matingly receive the glass attachment member 68 or 70 as the glass attachment member travels generally vertically during opening and closing of the window. The material is sufficiently durable to prevent undue wear and substantially captures the glass attachment member so that an edge of the glass is guided during translational movement.

A reinforcement member 100 may also optionally be provided within the extrusion. For example, the reinforcement member may be a metal member such as steel or aluminum, or non-metal member such as a rigid plastic. Of course, the particular material used should not be deemed to limit the subject invention. Preferably, the reinforcement member is entirely encapsulated within the extrusion and adds desired strength, form, and rigidity to the integrated assembly as is generally known in the art. Alternatively, the reinforcement member may be omitted, or the extrusion supported externally. Both reinforced and non-reinforced extruded profiles are common in the industry and thus would be apparent modifications to one of ordinary skill in the art.

A second or attachment portion 102 of the integral extrusion is also U-shaped to define a second channel that illustrates one version or method of attaching the assembly to the door, although it will be appreciated that other arrangements could be used. The cavity of the second channel is directed in generally the opposite direction of the first channel. One of the legs of the second channel is common with the first leg of the first channel, and thus is denoted by the same reference numeral 78. A second leg 104 is interconnected with the first leg via a third or interconnecting leg 106. Conventional gripping flanges 108 extend inwardly into the channel cavity from the first and second legs for a tight, gripping engagement with a door flange (not shown) in a manner that is generally conventional in the art. An extending lip 110 serves as a sealing lip, and gap hider that provides a smooth transition with the vehicle door to which the extrusion assembly is secured. In addition, the second channel 102 may also include a reinforcement member, shown here as an integral extension of reinforcement member 100. Again, if used, the reinforcement member is preferably encapsulated within the extrusion assembly.

A mounting flange or bracket 112 secures the section or portion of the integrated assembly below the belt line to the door. Although shown as a single bracket that extends across the entire lower portion of the integrated assembly, separate brackets located at spaced locations could also be used. Channel 102 may be replaced by other push-on fastener type arrangements or still other retention means could be used to facilitate attachment of the assembly to the door without departing from the scope and intent of the present invention.

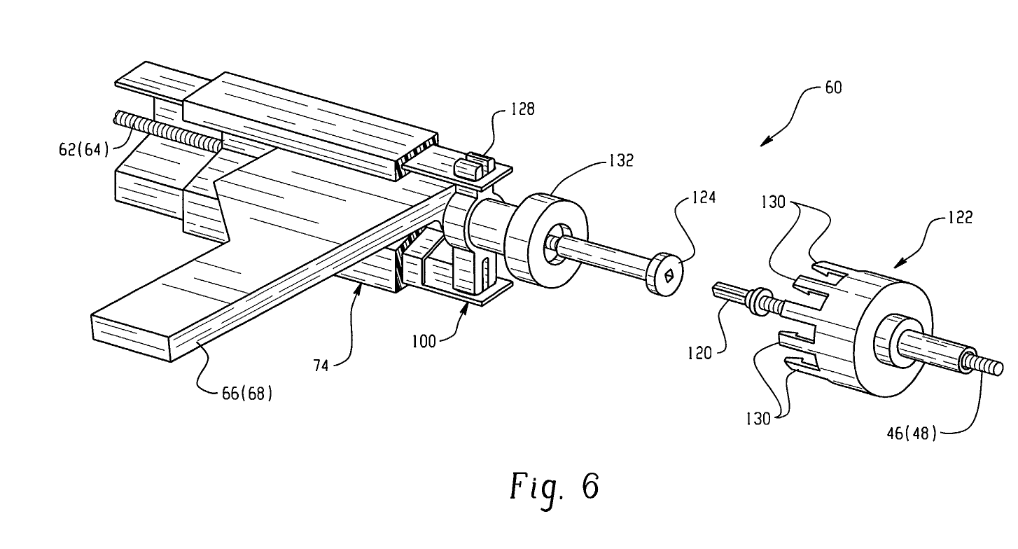

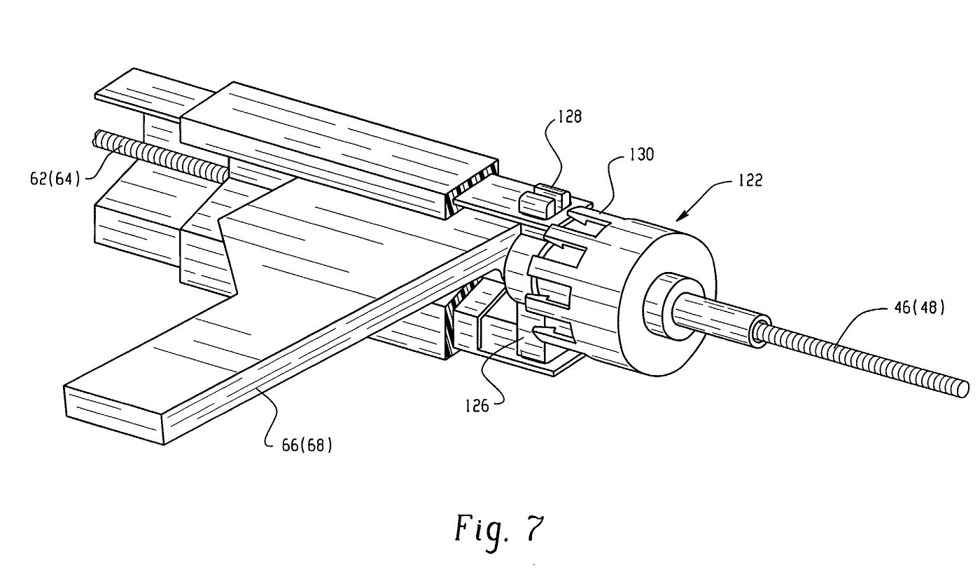

With continuing reference to FIGS. 1-4, and additional reference to FIGS. 5-7, the connector assembly 60 will be described in greater detail. The flexible drive shaft 46, 48 terminates in a square end or other connector 120 suitable to transmit power. Here, the shaft connector 120 (FIG. 6) is enclosed by an outer or female coupling portion 122. The second portion of the connector assembly 60 includes a female shaft connector 124 having a square opening or other polygon suitable to transmit power that matingly receives the square end 120 and is connected to at a second or opposite end to the screw 62 or 64. An inner or male coupling portion 126 is received about the shaft connector. Preferably the male coupling portion includes radially extending legs 128 that are non-rotatably received within one end of the front or rear pillar 50,52. Individual snap-fit legs 130 on the female coupling portion expand radially outward as the female coupling portion is axially advanced over shoulder portion 132 of the male coupling portion-126. In this manner, the coupling portions 122, 126 snap-fit together without use of any fasteners or tools to drivingly interconnect the flexible drive shaft 46, 48 with the screws 62, 64, respectively.

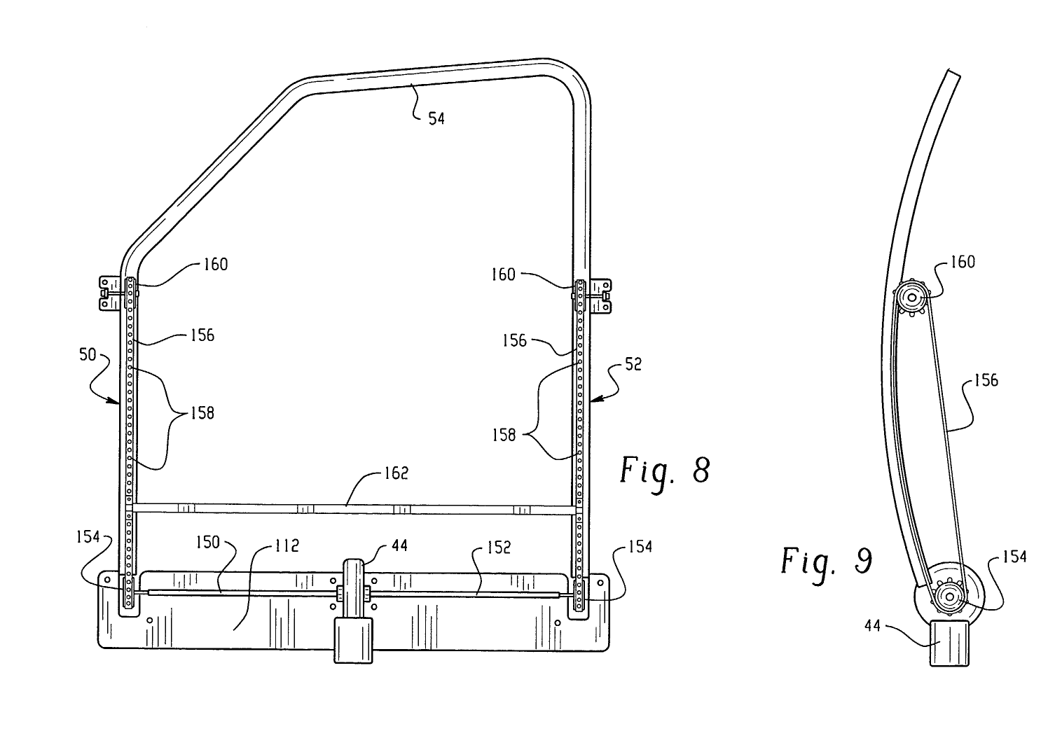

The embodiment of FIGS. 8 and 9 demonstrates that the integrated assembly 30 can employ different types of lift assemblies. Here, like components will be referred to by like reference numerals while new components use new reference numerals. Particularly, motor 44 includes drive shafts 150, 152 extending in opposite directions toward the front and rear pillars 50,52. A drive sprocket 154 is provided at an outer end of each shaft. Thus, as will be appreciated, the drive shafts 150, 152 are shown as a rigid, linear construction, although the flexible drive shafts described in the previous embodiment could also be employed. Extending around each drive sprocket is a flexible drive band 156 having spaced openings 158 therein that mesh or engage with the teeth in the drive sprocket and teeth in idler sprockets 160 disposed adjacent the waist line of the integrated assembly. As is particularly illustrated in FIG. 9, the drive band is adapted for movement in clockwise and counterclockwise directions to raise and lower a glass attachment bar 162. As is evident from the figure, the glass attachment bar extends across lower edge 164 of the glass. Alternatively, smaller glass attachment members similar to glass attachment members 66, 68 described with reference to the previous embodiment can be used at the edges of the window glass. If the front and rear pillars are not disposed in parallel relation, it is preferred to merely attach each drive band to the window via smaller attachment members, rather than a continuous attachment member that extends over the entire lower edge of the window glass.

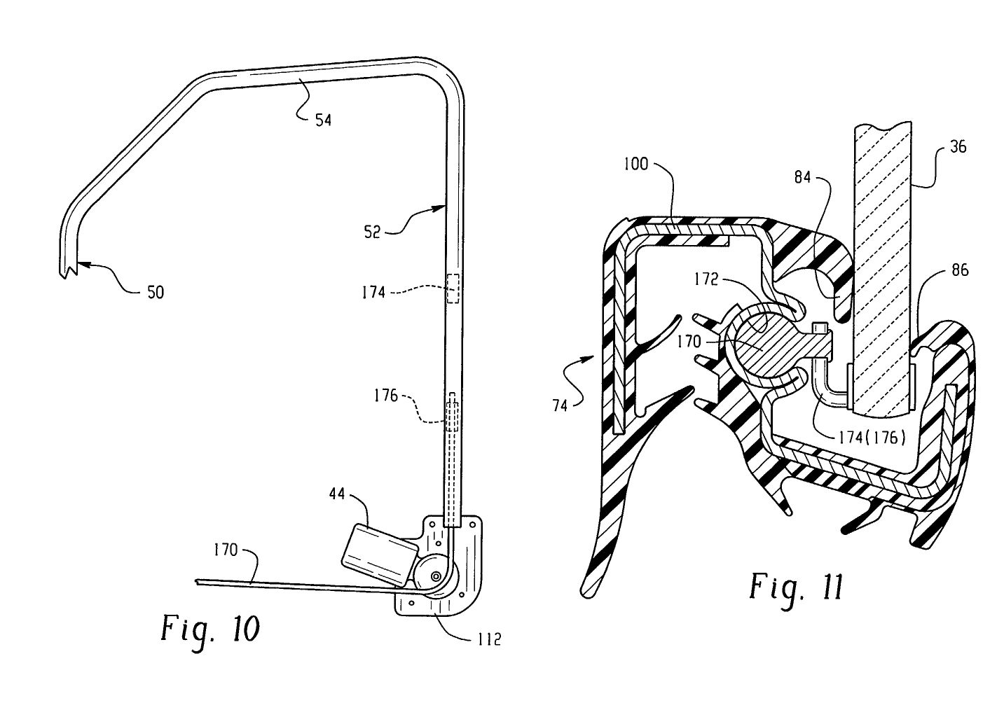

Another exemplary drive embodiment is illustrated in FIGS. 10 and 11. Here, motor 44 drives a single flexible cable 170. This flexible cable may be metallic or nonmetallic. Since the cable is constrained within a substantially circular recess 172 in the pillars, the cable is pushed and pulled by the motor to lift and lower the window to a closed position. In this embodiment, the drive cable 170 is secured to the window glass via first and second glass attachment members 174, 176. This mounting arrangement is required since the front and rear pillars are disposed in non-parallel relation. Thus as will be appreciated, the window is cantilever mounted to the drive cable along the rear edge of the glass, preferably at two spaced locations via the attachment members 174, 176.

As will be appreciated with reference to FIG. 10, an applique can be used to cover manufacturing imperfections and the like on the structural portion, for example, of the “B” pillar. As taught in U.S. Pat. No. 5,092,078, the applique can be used to extend over the surfaces forming the glassrun channel receiving portion of the “B” pillar. Such a modification can be easily incorporated into the integrated assembly without departing from the scope and intent of the present invention.

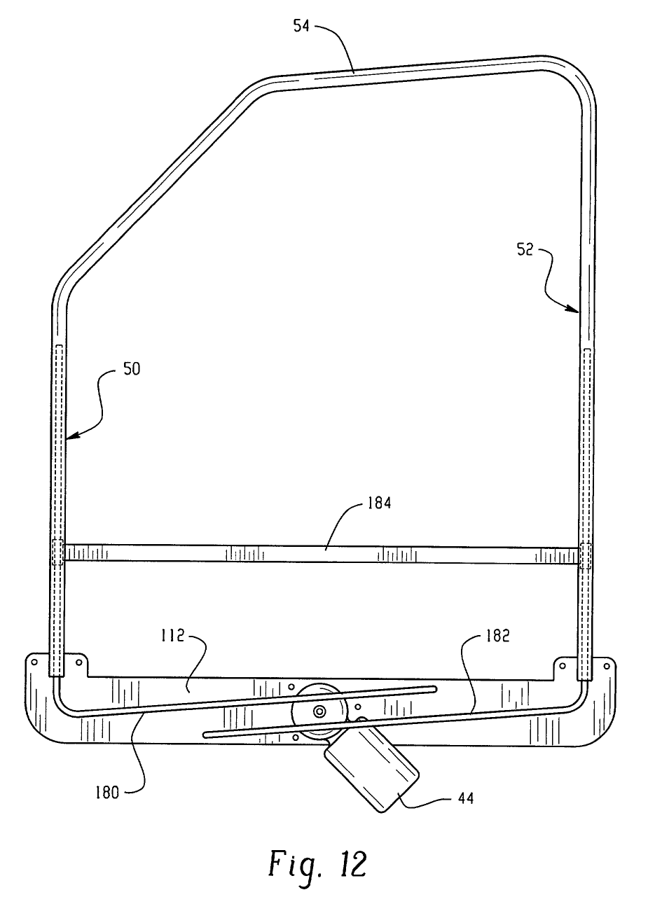

In FIG. 12, the front and rear pillars 50, 52 are disposed in parallel relation. Here, first and second drive cables 180, 182 cooperate with the common drive motor 44 to selectively raise and lower the window glass. As one skilled in the art will recognize, the attachment member 184 may extend over the entire lower edge of the window glass, i.e., from the front to the rear pillar, since the pillars are in parallel relation and the cables are driven in unison by the motor.

A substantial reduction in weight results from the integrated assembly. It is estimated that a weight reduction on the order of 1.75 to 2.00 pounds per door can be achieved through use of the integrated assembly when compared with separate glassrun and window regulator assemblies as are commonly used today. In addition, the integrated assembly will eliminate relays, electric switches, and reduce electrical wire size. Moreover, the assembly process is substantially simplified with a corresponding cost savings since the integrated assembly is pressed into place by the second channel gripping the inner periphery of the door assembly and by securing mounting flange 112 to the vehicle door. The window glass is also easily incorporated into the integrated assembly. As a result, a substantial reduction in the cost of manufacture and assembly is achieved.

It will also be appreciated that the integrated glassrun and drive system need only be provided below the belt waistline. That is, the upper glass run could be a separate glass run from the integrated regulator and glass tracking system that is located below the belt waistline. Such an arrangement would still achieve some of the benefits noted above without being an entirely integrated assembly, i.e., that incorporates the upper glassrun.

The invention has been described with reference to the preferred embodiments. Obviously, modifications and alterations will occur to others upon reading and understanding the detailed description. It is intended to include all such modifications and alterations insofar as they fall within the scope of the appended claims and the equivalents thereof

Having thus described the invention, it is now claimed:

1. An integrated glass run and window regulator assembly comprising:
a glass run assembly dimensioned for receipt within an associated door window opening and including a channel having inner and outer surfaces dimensioned to receive an associated window edge therein; and
a lift assembly for selectively lifting and lowering an associated window, the lift assembly and glass run assembly unitarily joined for mounting in an associated vehicle door.

2. The integrated assembly of claim 1 wherein the channel extends above and below a waistline, and a portion of the channel below the waistline guiding the window as the window is selectively lifted and lowered.

3. The integrated assembly of claim 1 wherein the lift assembly includes a motor for driving the lift assembly.

4. The integrated assembly of claim 3 further comprising a generally U-shaped portion dimensioned for engagement with a flange of the associated door.

5. The integrated assembly of claim 4 further comprising a reinforcing member operatively associated with the channel.

6. The integrated assembly of claim 5 wherein the reinforcing member is operatively associated with the generally U-shaped portion.

7. The integrated assembly of claim 1 further comprising a reinforcing member operatively associated with the channel.

8. The integrated assembly of claim 7 wherein the reinforcing member is metal.

9. The integrated assembly of claim 7 wherein the reinforcing member is non-metal.

10. The integrated assembly of claim 1 wherein a portion of the lift assembly extends into the channel.

11. The integrated assembly of claim 1 wherein the lift assembly includes a screw drive member extending along a first side of the assembly, and a follower adapted to be secured to the associated window.

12. The integrated assembly of claim 11 wherein the lift assembly includes a second screw drive member extending along a second side of the assembly.

13. The integrated assembly of claim 12 further comprising a support member dimensioned to extend across a bottom of the associated window.

14. The integrated assembly of claim 11 wherein the screw drive member is received in the channel.

15. The integrated assembly of claim 11 wherein the lift assembly further comprises a motor and a flexible drive shaft operatively interconnecting the motor to the screw drive member.

16. The integrated assembly of claim 1 wherein the lift assembly includes a flexible cable driven by a motor, and the cable extends along at least one side of the integrated assembly.

17. The integrated assembly of claim 16 wherein the lift assembly includes first and second attachment members that secure the cable to an associated window.

18. The integrated assembly of claim 1 wherein the lift assembly includes a flexible cable driven by a motor, and the cable extends along first and second sides of the assembly.

19. The integrated assembly of claim 18 wherein the lift assembly includes first and second attachment members disposed on opposite sides of the assembly.

20. The integrated assembly of claim 1 wherein the lift assembly includes drive and idler sprockets in spaced relation and a flexible band in closed loop relation therewith.

21. The integrated assembly of claim 20 wherein the band includes a glass attachment member adapted to secure the band to an associated window glass.

22. The integrated assembly of claim 1 wherein the channel includes a low friction material disposed in a base portion thereof.

23. The integrated assembly of claim 1 wherein at least the glass run assembly includes a reinforcing member encapsulated in one of an extruded rubber and plastic material thereover.

24. The integrated assembly of claim 23 wherein the reinforcing member is provided in only the glass run assembly.
